(19) United States
(12) Patent Application Publication
(10) Pub. No.: US 2016/0376084 A1
(43) Pub. Date: Dec. 29, 2016

(54) NON-WOVEN CONTAINER THAT FORMS A NAPKIN

(71) Applicants: Michael Wein, Houston, TX (US); Phillip Sarofim, Houston, TX (US)

(72) Inventors: Michael Wein, Houston, TX (US); Phillip Sarofim, Houston, TX (US)

(21) Appl. No.: 15/192,815

(22) Filed: Jun. 24, 2016

Related U.S. Application Data
(60) Provisional application No. 62/185,396, filed on Jun. 26, 2015.

(51) Int. Cl. B65D 81/36; B65D 33/00; A41D 13/04; B65D 33/02; A41B 13/10; A47J 47/14; B65D 30/08

(52) U.S. Cl. CPC B65D 81/363; A47J 47/14; B65D 33/004; B65D 31/02; B65D 33/02; A41B 13/10; A41D 13/04

(57) ABSTRACT

A full size non-woven container for carrying prepared food. The container has a front side, a back side, and a bottom integrally connected to and between the front side and the back side and a plurality of tear away perforations, wherein a first group of perforations are configured to separate a portion of the full size non-woven container forming a reduced size container while simultaneously forming at least one napkin, a third group of perforations of the tear away portions form a bib and a second group of perforations of tear away portions form a tray. The reduced size container also configured to continue to carry prepared food.

### CROSS REFERENCE RELATED APPLICATION

The present application claims priority to and the benefit of co-pending U.S. Provisional Patent Application Ser. No. 62/185,396 filed on Jun. 26, 2015, entitled “NON-WOVEN CONTAINER THAT FORMS A NAPKIN”. This reference is hereby incorporated in its entirety.

### FIELD

The present embodiments generally relate to a non-woven container forming at least one napkin while continuing to maintain a container for holding and transporting prepared food.

### BACKGROUND

A need exists for a fast food bag that can form a napkin, a bib, and a tray simultaneously from the same container while having a leak proof coating and a color changing coating to indicate food temperature.

The present embodiments meet these needs.

### BRIEF DESCRIPTION OF THE DRAWINGS

The detailed description will be better understood in conjunction with the accompanying drawings as follows:

FIG. 1 is a top perspective view of a full size non-woven container according to one or more embodiments.

FIG. 2 is a top perspective view of the full size non-woven container with three napkins removed according to one or more embodiments.

FIG. 3 is a view of the reduced size non-woven container with a detached napkin according to one or more embodiments.

FIG. 4 is a top view of a food organizer that can be used in the bottom of the reduced size non-woven container according to one or more embodiments.

FIG. 5 is a cut view of a back side of a full size non-woven container with a color changing coating on one side and a leak resistant coating on an opposite side according to one or more embodiments.

FIG. 6 is a view of the full size non-woven container with a glove according to one or more embodiments.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments generally relate to a non-woven container forming at least one napkin while continuing to maintain a container for holding and transporting prepared food.

The embodiments relate to the non-woven container for prepared food with perforations designed to tear away enabling the non-woven container to be reduced in size.

The embodiments further relate to a full size non-woven container configured to carry prepared food having a front side, a back side integrally connected to the front side, a bottom integrally connected to and between the front side and the back side simultaneously.

The bottom, back side and front side can each have at least one of: a post-consumer recycled paper sheet, a hydrophilic fabric material, a hydrophobic sheet material, a cotton based fabric, a linen based fabric, a polyester fabric, a polyester blend fabric, a compostable cellulose/pulp based sheet material, cellulose/pulp based sheet material, a recyclable cellulose/pulp based sheet material, a quilted absorbent sheet material, a multi-ply sheet material or combinations thereof. In embodiments, each sheet or fabric can have a thickness from 0.1 mm to 5 mm.

In embodiments, a first group perforations can be formed in either the front side or the back side, wherein the first group of perforations can be configured to separate at least one absorbent napkin from a portion of the back side or front side, while forming a reduced size container configured to carry prepared food for a user.

In embodiments, a second group of perforations can be formed in either the front side or the back side proximate the bottom, wherein the second group of perforations can be configured to separate at least a portion of the bottom from the front side or the back side forming a tray used to hold and access prepared food for the user.

The embodiments further relate to a full size non-woven container with a front side, a back side integrally connected to the front side, and a bottom integrally connected to and between the front side and back side.

Tear away perforations formed on the non-woven container can be configured to separate a portion of the full size non-woven container forming a reduced size container while simultaneously forming a napkin. Both the reduced size container and the full size container can be configured to continue to carry the prepared food.

The benefits of the invention, also known as “the napkin bag” can include: eliminating excess waste of paper by enabling a user to reuse a portion of the bag that is otherwise just thrown away. Packaging bags and separate napkins are already being used and thrown away more than necessary and at additional expenses to a restaurant or a fast food restaurant.

Often times, a user will take a big stack of napkins that are never used, and throw them away unused after his meal. When the napkin is included as part of the bag, there is less opportunity for an unthinking user to waste paper and pulp and create trash.

The term “absorbent napkin” as used herein can refer to a material that holds a fluid based product, such as milk or ketchup, soda or coffee of ⅛ of an ounce to 2 ounces.

The term “cellulose/pulp based sheet material” as used herein can refer to a material, which can be made from a wood product. The term “cellulose/pulp based sheet material” as used refer can refer to the common material of plant cell walls as first recognized by Anselm Paven in 1838.

The term “compostable cellulose/pulp based sheet material” as used herein can refer to a wood product that can reduce in about 6 weeks into usable compost. The term “compostable cellulose/pulp based sheet material” as used herein can refer to a material that biodegrades completely into substances that are healthy or at least harmless for soil and plants.

Other compostable materials can include starches, biopolymers, bioplastics and a variety of other known materials.

The term “full size non-woven container” as used herein can refer to an envelope like container or a four sided bag.

The term “a hydrophilic sheet material” as used herein can be a flexible material with a special affinity for water. Hydrophilic materials spread water across its surface maximizing contact and liquid absorption. The term “a hydrophobic sheet material” can refer to a fabric that naturally repels water, causing droplets to form on its surface.

The term “integrally connected” as used herein can refer to as a front side being glued to the back side, or the front side being made of a material that is the same sheet that the back side if formed from.

The term “multi-ply sheet material” as used herein can refer to a one ply, a two ply or a three ply laminate flexible sheet.

The term “napkin bag” as used herein can refer to a container that is good for the environment and provides cost savings for food supplying businesses. The napkin bag can additionally save on labor as well as supplies, as the “napkin bag” can also reduce the packing time needed to complete a food order.

The term “a polyester blend fabric” as used herein can refer to a thin fabric made from fibers of polyester and other material, such as cotton. In embodiments, the polyester blend fabric can be synthetic fibers blended together into a sheet.

The term “post-consumer recycled paper sheet” as used herein can refer to an at least 10 percent post-consumer recycled material.

The term “prepared food” as used herein can refer to but is not limited to food, such as fast food, fresh food, ordered food, a cooked edible meal or combinations thereof

The term “quilted absorbent sheet material,” as used herein can refer to a material, such as quilted toweling with stitching that can create pattern, such as logos, or names.

The term “recyclable cellulose/pulp based sheet material” as used herein can refer to a material that can be easily broken down and reused as a usable paper product with minimal energy and waste.

In embodiments, the front side can be from 1 inch to 18 inches wide and from 2 inches to 24 inches high. The front side can have a thickness from 0.1 mm to 5 mm.

In embodiments, the back side can be from 1 inch to 18 inches wide and from 2 inches and 24 inches high. The back side can have a thickness from 0.1 mm to 5 mm.

In embodiments, the bottom can have dimensions from 1 inch to 24 inches wide and from 1 inch to 24 inches in length. The bottom can have a thickness from 0.1 mm to 5 mm.

In embodiments, the first side can be from 1 inch to 18 inches wide and from 2 inches to 24 inches high. The first side can have a thickness from 0.1 mm to 5 mm.

In embodiments, the second side can be from 1 inch to 18 inches wide and from 2 inches to 24 inches high. The second side can have a thickness from 0.1 mm to 5 mm.

The bottom, back side and front side each can be made from at least one of: a post-consumer recycled paper sheet, a hydrophilic fabric material, a hydrophobic sheet material, a cotton based fabric, a linen based fabric, a polyester fabric, a polyester blend fabric, a compostable cellulose/pulp based sheet material, a recyclable cellulose/pulp based sheet material, a quilted absorbent sheet material, a multi-ply sheet material or combinations thereof.

In embodiments, the non-woven container can include a food divider. A benefit of the food divider is that the food divider, when integral with the bag keeps the customer's food organized. This food organizer integral with the non-woven container or bag with napkin is important for both the customer and the restaurant as the combination of the three items can reduce complaints and improve customer happiness.

With current solutions, food often spills in the bottom of the bag, such as French fries, which can fall out of their container and are lost in the bottom of the bag growing cold. With the food organizer in the bottom of the bag, the chance of food spilling is greatly reduced. Moreover, this food organizer allows for easy checking of an order by a worker to ensure all the correct pieces of the order are included in the non-woven container.

In embodiments, the napkin bag can have at least one pocket. In embodiments, the at least one pocket can be connected to the front side, the back side, an integral a first side or an integral backside. The at least one pocket can perform a similar function, such as allowing easy checking by an employee to confirm that all required condiments and/or utensils are included in the napkin bag. Because the condiments and utensils are no longer lost in the bottom of the napkin bag beneath the spilled food items, consumers can easily locate these items at the beginning of the meal, which is when these items are needed.

The ability for the top of the non-woven container to be removed as a napkin while leaving a reduced size container with an included tray intact at the bottom is a huge benefit to anyone eating on the go.

No longer does a customer have to sift through the contents of the non-woven container to determine what is inside. The customer has only to simply remove the napkins by tearing at a first group of perforations then tearing at a second group of perforations or the tray perforations to have access to a tray for easy access while eating.

In an embodiment, the non-woven container can contain an integral bib. A bib is especially beneficial to anyone with small children or elderly folks who can't keep food easily in their mouths. The bib can be integral in the non-woven container and easily removed by using a third group of perforations to separate the bib from the non-woven container.

Food can often be messy, but with non-woven container, the customer, also termed “user” herein, can be provided with a bib and a tray simultaneously in the non-woven container that can also provide at least one napkin and a carrying container.

The non-woven container can help eliminate food messes and is a great solution for both parents on the go and for businesses that serve meals specifically for children.

In many countries, napkins are not even given with a meal, but bags are given with takeaway. In this instance, the customer can benefit because this invention adds function to an already disposable item.

In embodiments, the prepared food can be fast food, fresh food, ordered food or combinations thereof.

In embodiments, the pocket can be removably attached to the full size non-woven container.

In embodiments, the pocket can be configured to support and contain a food additive, utensils, condiments, a side dish, or combinations thereof, for use with the prepared food.

In embodiments, the pocket can be an interior pocket or an exterior pocket formed on the front side or the back side interior of the full size non-woven container.

In embodiments, the food organizer can be mounted to the bottom within the full size non-woven container to separate food items.

In embodiments, the non-woven container can include the bib formed from the perforations, in which the bib can be configured to secure around a neck of a user. The bib can remain attached to the tray when in use or can be removed from the tray.

The terms “napkin bag or bag” as used herein refers to the full size non-woven container which can be reduced to a reduced size container when one or more napkins are removed along a first group of perforations. In embodiments, the napkin bag or bag can also include the tray, which can be separated using a second group of perforations, and a bib, which can be separated using a third group of perforations.

In embodiments, the first group of perforations, the second group perforations, the third group of perforations, and the fourth group of perforations, and combinations thereof can be formed in a line, or linearly, and have a density from 3 holes per inch to 12 holes per inch, wherein each hole can have a diameter ranging from 0.1 mm to 3 mm.

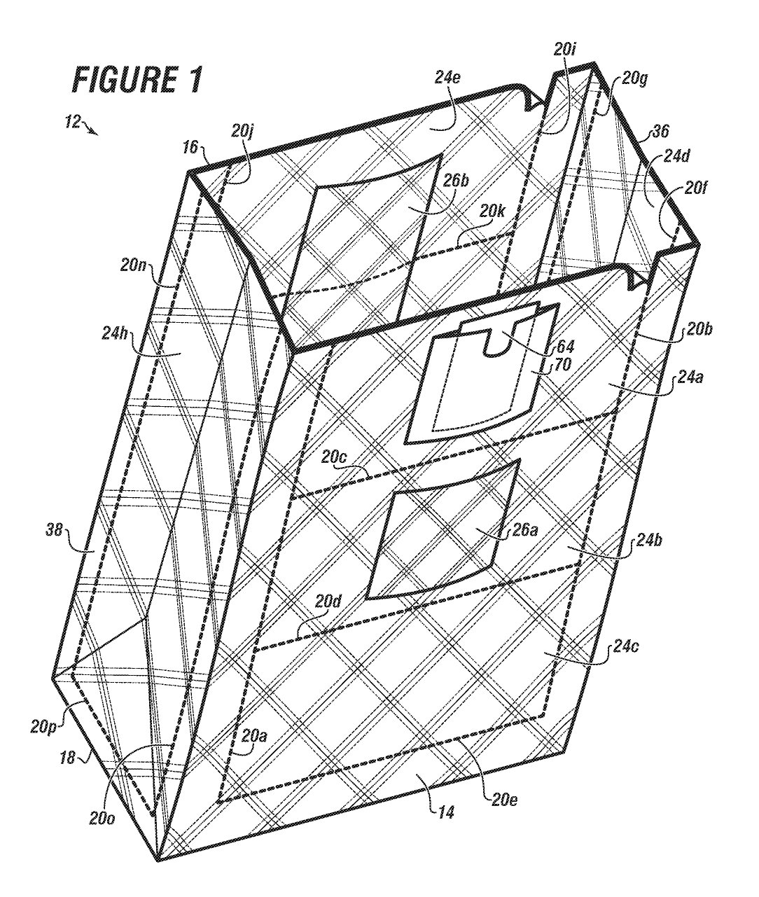

Turning now to the Figures, FIG. 1 is a top perspective view of a full size non-woven container according to one or more embodiments.

The full size non-woven container 12 can have a front side 14 and a back side 16. A bottom 18 can be integrally connected to the front side and the back side simultaneously.

In embodiments, the full size non-woven container 12 has a front side 14 and a back side 16 integrally connected to the front side like an envelope.

In embodiments, the full size non-woven container can be paper or fabric. In other embodiments, the container can be made of woven or non-woven material.

In embodiments, the material of the container can be post-consumer recycled paper, cotton based fabric, cellulose/pulp based material, quilted absorbent material, or combinations thereof.

The material can range in thickness from 0.2 mm to 1 cm.

The bottom 18 can have a shape selected from the group comprising: rectangular, square, circle, oval, pentagon, hexagon, heptagon, octagon, another polygonal shape or combinations thereof.

A first group of perforations 20a-20p can be used to separate a portion of the full size non-woven container to form at least one napkin 24a-24h from the full size non-woven container 12. The first group of perforations can be formed on the front side 14, the back side 16 and optionally an integral first side 36 and/or an integral second side 38. Once torn, the first group of perforations can create one or more napkins.

In this embodiment, the first group of perforations 20c and 20k can be formed at equal distances, such as about 3 inches from a top edge of the full size non-woven container 12.

The full size non-woven container can hold prepared food such as fast food, fresh food, ordered food, or combinations thereof.

At least one pocket 26a and 26b can be removably attached to the full size non-woven container 12. The at least one pocket can be configured to support and contain a food additive, a utensil, a condiment, a toy, or combinations thereof, for use with the prepared food. The toy, for example, could be included in the pocket of a HAPPY MEAL at MCDONALDS®.

In embodiments, the at least one pocket can be secured to the front side or the back side of the full size non-woven container.

The pocket can made from the same material as the full side non-woven container.

The pocket can be flexible and from 0.1 mm to 3 mm in thickness. The pocket can be attached to the full size non-woven container with glue, melted glue, stitching or staples. The pocket can be in the form of a hand forming a glove with the front side or the back side of the full size non-woven container.

In embodiments, the full size non-woven container can have a transparent holder 70, which can be integrally formed on an outer surface of the full size non-woven container, which can be configured to hold and allow an order receipt 64 to be seen through the transparent holder.

In embodiments, the transparent holder 70 can be integrally formed on an outer surface. In embodiments, the transparent holder can be from 2 inches by 2 inches in length. In embodiments, the transparent holder can be compression pressed to the non-woven full size container. The transparent holder can be a piece of clear plastic. In embodiments, the transparent holder can be a sheet which can be from 0.1 mm to 3 mm in thickness and can be flexible. The transparent holder can be attached to the full size non-woven container with glue, melted glue, stitching or staples.

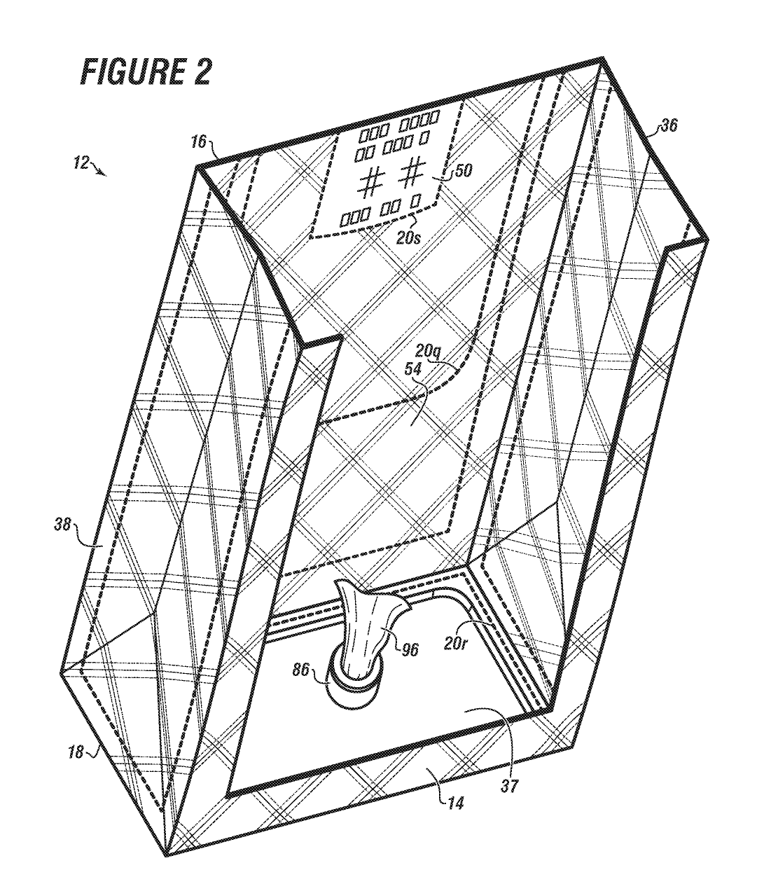

FIG. 2 is a top perspective view of the full size non-woven container with three napkins removed according to one or more embodiments.

In this embodiment, the full size non-woven container 12 is shown with three of the napkins torn away from the full size non-woven container along the first group of perforations.

In embodiments, the full size non-woven container can have a bib 54, which can be formed from a third group of perforations 20q. The bib 54 can be configured to secure around a neck of a user.

In embodiments, the bib 54 of the full size non-woven container can be made of a different material. In embodiments, the bib 54 can be formed from the integral first side 36 or the integral second side 38 of the full size non-woven container.

In embodiments, the bib can be made of a cotton blend, a hydrophobic sheet material or a coated layer formed as an integral part of the full size non-woven container.

The full size non-woven container 12 can contain a second group of perforations 20r at every juncture between the bottom 18 and the front side 14, the bottom 18 and the integral first side 36, the bottom 18 and the back side 16 and the bottom 18 and the integral second side 38 of the full size non-woven container. The second group of perforations, which can be tray forming perforations, can be configured to form a tray 37 when the second group of perforations are torn.

The tray 37 can be formed in the bottom 18 of the full size non-woven container and can have handles, which can be secured to the outer portion of the full size non-woven container to support the tray, and allow a user to carry the tray.

In embodiments, the tray 37 can be formed from less than ½ of the bottom 18 of the full size non-woven container and can include at least one of: a stiffened backing, such as cardboard, a reinforced material, such as a plastic sheet, or a non-porous material, such as thin film metal sheet, which can still be flexible and foldable, such as aluminum.

The bottom 18 of the full size non-woven container can be configured to have two different portions in this embodiment.

The second group of perforations 20r or tray forming perforations can be punched through the material of the full size non-woven container 12 at every juncture between the front side 14, the integral first side 36, the back side 16, and integral second side 38 of the full size non-woven container just proximate the bottom 18.

In embodiments, at least one internal tail 86 can be located at the bottom 18 of the full size non-woven container and can have a pull out napkin 96.

In other embodiments, the tray 37 does not include an internal tail.

The internal tail 86 can be a detachable and removable napkin attached to an interior of the full size non-woven container.

In embodiments, the full size non-woven container can have from 1 internal tail to 3 internal tails. In this embodiment, the internal tails can be rolled napkins attached at one end like a coiled tube. In other embodiments, the internal tails can be folded on top of each other and secured integrally together, with perforations for tearing portions of napkins from the internal tails.

In embodiments, the internal tails can be glued to the interior of each bottom of each full size non-woven container. In embodiments, the internal tails can be connected to the bottom of the full size non-woven container.

In embodiments, an integral removable educational piece 50 can be removable along a fourth group of perforations 20s and integral with the back side 16 of the full size non-woven container 12.

The integral removable educational piece 50 can be integral with the integral first side 36, the integral second side 38, the front side 14 or the back side 16 and separable from the side using the fourth group of perforations 20s.

The integral removable educational piece 50 can provide information on history, a game about Presidents of the United States, a word of the day trading card, a game piece or similar component to operate with a board given away by the establishment or to operate based on rules printed on the full size non-woven container or on a reduced size container.

The integral removable educational piece can be a tear off trading card, wherein each full size non-woven container can have a story of a great inventor, like Albert Einstein, Howard Hughes, and Jackson Pollock.

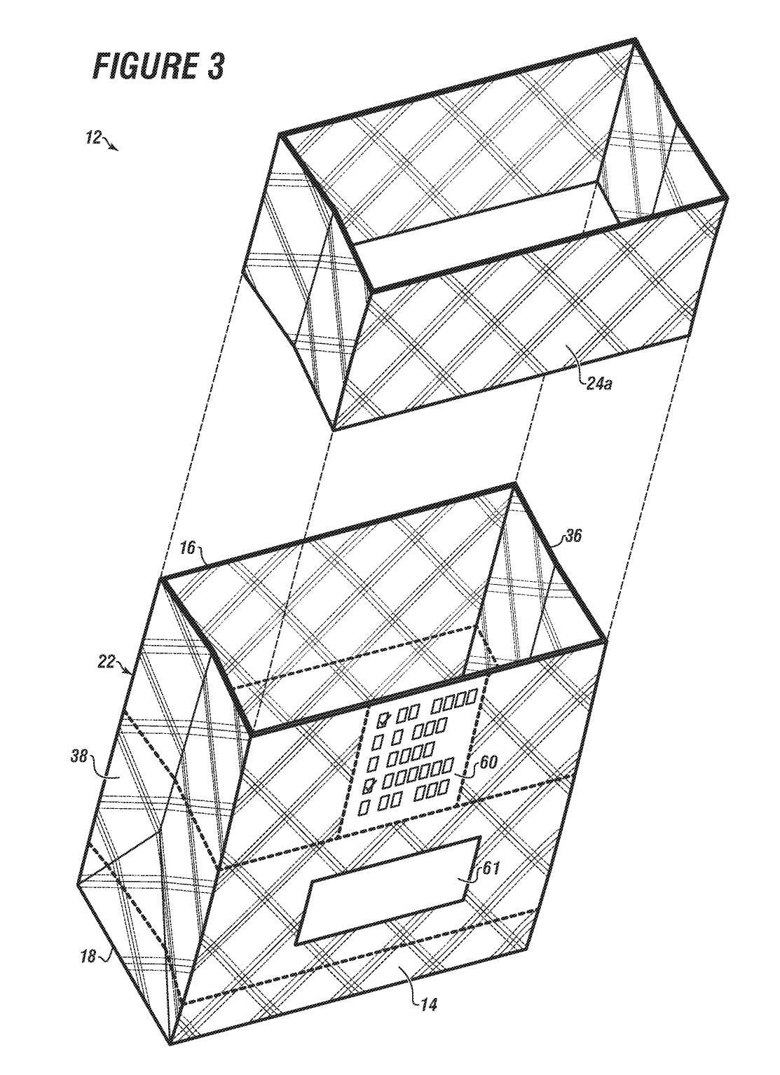

FIG. 3 is a view of the reduced size non-woven container with a detached napkin according to one or more embodiments.

In this embodiment, the full size non-woven container 12 is shown with a detached napkin 24a, which is formed from the front side 14, the back side 16, the integral first side 36 and the integral second side 38.

Once torn, the at least one napkin 24a is formed leaving a reduced size container 22.

The reduced size container 22 can be large enough to carry prepared food and has the same identical bottom 18 as the full size non-woven container 12.

In embodiments, the reduced size container 22 can have a height of 4 inches and the same width and thickness of the full size non-woven container. In embodiments, the reduced size container 22 can be 50 percent the height of the original full size non-woven container 12.

In embodiments, the at least one napkin can be from 6 inches to 4 inches in length and can range in size from 3 inches to 12 inches in width.

In embodiments, the at least one napkin can be a different material than the material used to make other portions of the reduced size container. In embodiments, the at least one napkin can be made of the same material as the integral second side, the integral first side and the bottom of the full size non-woven container.

In embodiments, the full size non-woven container 12 can have an order slip 60, which can be integrally formed on an outer surface of the full size non-woven container to identify the user, or customer name, an order number, an order name, contents of the order, a time the order was placed, or combinations thereof.

The order slip 60 can be used to provide the individualized order requirements for food to be inserted in the full size non-woven container 12, such as ordered items, such as curly fries, apple pie, no-mustard burger, and order size, such as small, medium, large, extra-large, or giant sized.

In embodiments, the full size non-woven container 12 can have a messaging surface 61. The messaging surface 61 can be formed on an outer surface of the full size non-woven container 12 or on an outer surface of the reduced size container 22.

The messaging surface 61 can be configured to provide a message when written on by a stylus, a non-ink tool or a finger.

The messaging surface can be made of a flexible polymer film, such as a flexible polypropylene or polyethylene. In embodiments, the messaging surface can be made from a non-hydrocarbon based material. In embodiments, the messaging surface can be a paint.

In embodiments, the messaging surface 61 can enable the fingernail of the user to write a message, or can accept a message written with a crayon, a dry erase marker, or chalk.

The messaging surface can be a material painted on the front side or the back side of the back in an area such as 0.5 inch wide to the full width of the container to 0.5 inch in height to the entire height of the container. The paint can be a SHERWIN WILLIAMS® brand paint, which can create a chalk like surface when cured.

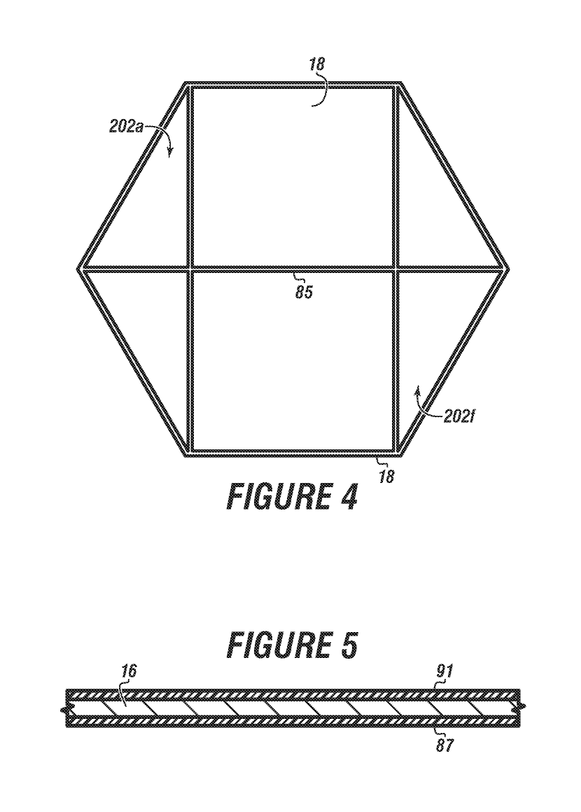

FIG. 4 is a top view of a food organizer that can be used in the bottom of the reduced size non-woven container according to one or more embodiments.

The food organizer can have a height from 1 inch to 6 inches and fit within the container and can have a width that is identical to the non-woven container. The food organizer can be made from the same material as the bottom, the front side and sides of the non-woven container.

In this embodiment, a food organizer 85 is shown mounted to the bottom 18 of a full size non-woven container or the reduced size container. The food organizer can have walls to separate food items into compartments 202a-202f.

In embodiments, the food organizer 85 can have from 2 food compartments to 6 food compartments. Each compartment can be made from the same material as the napkin material. In other embodiments, the food organizer can be a different material than the napkin, such as a material having a wax coating.

In embodiments, the food organizer can be integrally secured to the bag and non-removable.

FIG. 5 is a cut view of a back side of a full size non-woven container with a color changing coating on one side and a leak resistant coating on an opposite side according to one or more embodiments.

In embodiments, the full size non-woven container or the reduced size container can have a color changing coating 87 on an outside surface.

The color changing coating can be a thermochromism type material, such as organic materials, inorganic materials, dyes, papers, polymers and ink.

In embodiments, the full size non-woven container or the reduced size container can have a leak resistant coating 91 on an inside surface. In embodiments, the leak resistant coating can also be on the internal surface of the bottom of the full size non-woven container or the reduced size container. A layer of plastic wrap, wax paper, butcher paper, or similar material can be adhered to the other material of the container to create a usable leak resistant coating.

In embodiments, the entire full size non-wove container or the reduced size container, but not the napkin portions, can have both, the color changing coating and the least resistant coating disposed on the front side, the back side, the integral first side and the integral second side.

In embodiments, the color changing coating 87 can be a chemical configured to change color as temperature of prepared food in the full size non-woven container or the reduced size container changes temperature. For example, the full size non-woven container or the reduced size container can turn red for hot food and blue for cool food.

In embodiments, the leak resistant coating 91 can be disposed on the inside surface of the full size non-woven container or the reduced size container, but omitted from the napkin portions providing a leak resistant area for the prepared food.

In embodiments, each coating can have a thickness from 0.1 mm to 4 mm.

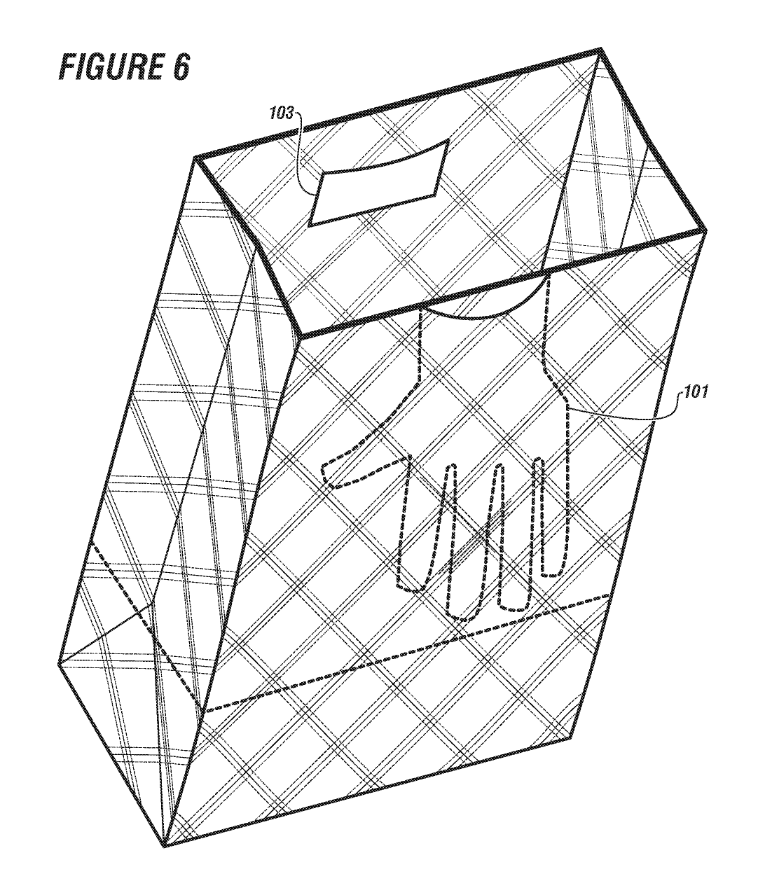

FIG. 6 is a view of the full size non-woven container with a glove according to one or more embodiments.

In embodiments, the pocket can be in the form of a hand forming at least one glove 101 with the front side or the back side of the full size non-woven container.

The at least one glove 101 can be formed from the first group of perforations, wherein the at least one glove can be configured to secure around a hand of a user. The at least one glove can be removable from the container or can remain at least partially attached when being used.

In embodiments, the non-woven container can contain at least one handle 103. In embodiments, which can be secured to the outer portion of the full size non-woven container to support the tray, and allow a user to carry the tray.

In an embodiment, the full size non-woven container or reduced size container can be shaped as an envelope. In this “envelope” shaped version of the full size non-woven container or reduced size container, a portion of the container can be an integral flap that can close over the contents. The flap can also serve as a removable napkin.

In embodiments, the bottom can have a shape selected from the group comprising: rectangular, square, circle, oval, pentagon, hexagon, heptagon, octagon, another polygonal shape, or combinations thereof.

As an example of use for a restaurant, the full size non-woven container or “napkin bag” can be useful with to-go orders. For example, when the initial order is placed, an order receipt can be generated from a cash register. By attaching this order receipt to the full size non-woven container, in the transparent holder, the worker knows exactly what is needed in this bag without needing tape.

As each food item of the order comes down the line, the food can be packed in its appropriate spot in the food organizer in the bottom. It is very easy for the worker to verify exactly what is in the full size non-woven container and know when the food order is complete thereby reducing the number of times an inaccurate or incomplete order goes out to customers.

The at least one pocket of the full size non-woven container provides an easy access place to put condiments and/or utensils before the order is given to the customer. The full size non-woven container streamlines the order process thereby saving the restaurant time and money.

The full size non-woven container can have a messaging area to write a special order message, such as “no pickles” or for food allergies.

The full size non-woven container can have an integral “order slip” to indicate the order directly on the full size non-woven container, such as a check the box feature, if the order receipt from the cash register can't be used or if needed for special orders.

As another example, for the customer, the full size non-woven container can be useful with orders on the go. A husband, wife and two kids pull into a drive thru while on a road trip. They each order something different and the order comes out the window in record time. It is very easy for the mother to determine that the order is correct because she can look down into the full size non-woven container and see the order sorted with the food organizer. She can also check the transparent window, the messaging area and the order slip.

As another example, a father is driving the car, so he rips off one large napkin from the side of the full size non-woven container and places it in his lap.

The two children in the back of the car each have their own full size non-woven container as well. The older of the children rips off all the napkins to form a tray that sits in his lap. He is now able to see his entire order in front of him, all organized in a food organizer while still being in a container that prevents spillage.

The younger of the two children is much messier and requires a bib when he eats. The mother immediately solves this problem by tearing the bib from the kid's the full size non-woven container as well as removing the napkins, leaving behind a tray with the food. The mother ties the now separated bib from the full size non-woven container around the child's neck leaving the child with all of his food in front of him. As the messy younger child eats his spills are contained within the tray, thereby eliminating much of the mess.

After the mother sorts out her two children, she sets her own full size non-woven container in her lap. Her salad is to be eaten with utensils, which are easily found in the at least one pocket of her full size non-woven container and not underneath the French fries. She eats her salad, then rips off the napkin and wipes her mouth knowing that everyone got the right order in a timely fashion and that the mess created by her two kids in the back and her husband who is focused on the road will be minimal. She is also happy knowing that she made less of an impact on the landfill because the full size non-woven container she was already going to throw away served many purposes all at once.

In embodiments, the full size non-woven container can hold prepared food that is fast food, fresh food, ordered food, or combinations thereof.

In embodiments, the full size non-woven container can have at least one pocket, wherein the at least one pocket can be removably attached to the full size non-woven container, and wherein the at least one pocket can be configured to support and contain at least one of: a food additive, utensils, a condiment, a toy, or combinations thereof, for use with the prepared food.

In embodiments, the at least one pocket can be secured to the front side or the back side of the full size non-woven container.

In embodiments, the food organizer can be attached to the bottom within the full size non-woven container.

In embodiments, the bib can be formed from a third group of perforations, wherein the bib can be configured to secure around a neck of a user that is either an adult or a baby.

In embodiments, the integral removable education piece can be integral with either the integral first side, the integral second side, the front side or the back side separable using a fourth group of perforations.

In embodiments, the bottom can be formed in a shape selected from the group: a rectangular, a square, a circle, an oval, a pentagon, a hexagon, a heptagon, an octagon, an additional polygonal shape, or combinations thereof.

In embodiments, the messaging surface can be integral with the front side or the back side of the full size non-woven container, wherein the messaging surface can be configured to form into a message when written on by a stylus, a non-ink tool, or a finger.

In embodiments, the order slip can be integral with the front side or the back side of the full size non-woven container to identify a customer, an order number, an order name, an order content, a time an order was placed, or combinations thereof.

In embodiments, the transparent holder can be integral with the front side or the back side of the full size non-woven container, wherein the transparent holder can be configured to hold an order receipt enabling the order receipt to be viewable through the transparent holder.

In embodiments, the color changing coating can be disposed on at least a portion of the front side or the back side of the full size non-woven container, wherein the color changing coating can be configured to change color as temperature of prepared food in the full size non-woven container changes temperature.

In embodiments, the leak resistant coating can be disposed on at least a portion of the front side, the back side, and the bottom of the reduced size container but omitted from coating napkins.

In embodiments, a metal foil can be laminated to at least one: the front side, the back side and the bottom, the metal foil can provide insulation to cold food or hot food, the metal foil can have a thickness of from 0.1 mm to 3 mm.

In embodiments, the internal tail can be mounted to the bottom providing a pull out napkin.

In embodiments, the full size non-woven container can have a front side and back side that can be made from different materials with different physical properties.

In embodiments, wherein the at least one of the front side, back side and bottom can be creped, embossed or combinations thereof.

The integral first side can be formed between the front side, back side and bottom of the full size non-woven container and the integral second side can be formed between the front side, back side and bottom opposite the first side.

In embodiments, the bottom can additionally comprise at least one of: a stiffened backing, a reinforced material, a hydrophobic sheet material, and a stiff non-porous material.

While these embodiments have been described with emphasis on the embodiments, it should be understood that within the scope of the appended claims, the embodiments might be practiced other than as specifically described herein.

What is claimed is:

1. A full size non-woven container configured to carry prepared food comprising:
a. a front side;
b. a back side integrally connected to the front side;
c. a bottom integrally connected to and between the front side and the back side simultaneously; the bottom, the back side and the front side each comprising a sheet or a fabric of at least one of: a post-consumer recycled paper sheet, a hydrophilic fabric material, a cotton based fabric, a linen based fabric, a polyester fabric, a polyester blend fabric, a compostable cellulose/pulp based sheet material, a cellulose/pulp based sheet material, a recyclable cellulose/pulp based sheet material, a quilted absorbent sheet material, a multi-ply sheet material or combinations thereof, wherein the sheet or the fabric having a thickness from 0.1 mm to 5 mm;
d. a first group of perforations formed in either the front side or the back side, the first group of perforations configured to separate at least one absorbent napkin from a portion of the back side or the front side, while forming a reduced size container configured to carry the prepared food for a user; and
e. a second group of perforations formed in either the front side or the back side proximate the bottom, the second group of perforations configured to separate at least a portion of the bottom from the front side or the back side forming a tray used to hold and access the prepared food for the user.

2. The full size non-woven container of claim 1, wherein the prepared food is fast food, fresh food, ordered food, or combinations thereof.

3. The full size non-woven container of claim 1, comprising at least one pocket, wherein the at least one pocket is removably attached to the full size non-woven container, and wherein the at least one pocket is configured to support and contain at least one of: a food additive, utensils, a condiment, a toy, or combinations thereof, for use with the prepared food.

4. The full size non-woven container of claim 3, wherein the at least one pocket is secured to the front side or the back side of the full size non-woven container.

5. The full size non-woven container of claim 1, comprising a food organizer attached to the bottom within the full size non-woven container.

6. The full size non-woven container of claim 1, comprising a bib formed from a third group of perforations, wherein the bib is configured to secure around a neck of the user.

7. The full size non-woven container of claim 1, comprising an integral removable education piece integral with either an integral first side, an integral second side, the front side or the back side separable using a fourth group of perforations.

8. The full size non-woven container of claim 1, wherein the bottom comprises a shape selected from the group: a rectangular, a square, a circle, an oval, a pentagon, a hexagon, a heptagon, an octagon, an additional polygonal shape, or combinations thereof.

9. The full size non-woven container of claim 1, comprising a messaging surface integral with the front side or the back side of the full size non-woven container, wherein the messaging surface is configured to form into a message when written on by a stylus, a non-ink tool, or a finger.

10. The full size non-woven container of claim 1, comprising an order slip integral with the front side or the back side of the full size non-woven container to identify a customer, an order number, an order name, an order content, a time an order was placed, or combinations thereof.

11. The full size non-woven container of claim 1, comprising a transparent holder integral with the front side or the back side of the full size non-woven container, wherein the transparent holder is configured to hold an order receipt enabling the order receipt to be viewable through the transparent holder.

12. The full size non-woven container of claim 1, comprising a color changing coating disposed on at least a portion of the front side or the back side of the full size non-woven container, wherein the color changing coating is configured to change color as temperature of prepared food in the full size non-woven container changes temperature.

13. The full size non-woven container of claim 1, comprising a leak resistant coating disposed on at least a portion of the front side, the back side, and the bottom of the reduced size container but omitted from coating napkins.

14. The full size non-woven container of claim 1, comprising a metal foil laminated to at least one: the front side, the back side and the bottom, the metal foil providing insulation to the prepared food, the metal foil having a thickness from 0.1 mm to 3 mm.

15. The full size non-woven container of claim 1, comprising an internal tail mounted to the bottom providing a pull out napkin.

16. The full size non-woven container of claim 1, wherein the front side and the back side can be made from different materials with different physical properties.

17. The full size non-woven container of claim 1, wherein at least one of: the front side, the back side and the bottom are creped, embossed or combinations thereof.

18. The full size non-woven container of claim 7, wherein the integral first side formed between the front side, the back side and the bottom and the integral second side formed between the front side, the back side and the bottom opposite the integral first side.

19. The full size non-woven container of claim 1 wherein the bottom additionally comprises at least one of: a stiffened backing, a reinforced material, a hydrophobic sheet material, and a stiff non-porous material.

20. The full size non-woven container of claim 1, comprising at least one glove formed from the first group of perforations, wherein the at least one glove is configured to slide around the hand of the user to keep the user's hand clean while eating the prepared food.
